(19) United States
(12) Patent Application Publication
(10) Pub. No.: US 2026/0127305 A1
(43) Pub. Date: May 7, 2026

(54) ACCESS CONTROL OF A NODE USING A CERTIFICATE AUTHORITY

(71) Applicant: Red Hat, Inc., Raleigh, NC (US)

(72) Inventors: Ygal Erol Blum, Toronto (CA); Pierre-Yves Chibon, Puteaux (FR)

(73) Assignee: Red Hat, Inc., Raleigh, NC (US)

(21) Appl. No.: 18/937,339

(22) Filed: Nov. 5, 2024

(51) Int. Cl. G06F 21/62; H04L 9/32

(52) U.S. Cl. CPC G06F 21/6218; H04L 9/3268; G06F 2221/2141

(57) ABSTRACT

In some examples, an access control system can use a certificate authority to implement access control of a node in a distributed computing system. The access control system can determine an access role of a node of one or more nodes in the distributed computing system. The access role can define one or more permissions of the node with respect to accessing system resources of the distributed computing system. The access control system can identify, based on the access control role of the node, a certificate authority corresponding to the access role. The access control system can assign, to the node, an access certificate generated by the certificate authority and corresponding to the access role of the node. The access control system can control, based on the access certificate of the node, whether an access request initiated by the node is allowed.

### TECHNICAL FIELD

The present disclosure relates generally to distributed computing systems. More specifically, but not by way of limitation, this disclosure relates to access control of a node in a distributed computing system using a certificate authority.

### BACKGROUND

Role-based access control systems are systems used to regulate access to system resources. Role-based access control systems may utilize access control policies to allow or deny an entity access to the system resources. The access control policies may be used to regulate access based on roles, permissions, or other factors associated with the entity requesting access or the requested system resources. In some instances, entities may submit access requests for accessing a system resource, such as a network resource, to the role-based access control system. The role-based access control system may determine applicable access control policies for the access request and may apply the access control policies to the access requests to determine if the entity is allowed to access the system resource.

### BRIEF DESCRIPTION OF THE DRAWINGS

FIG. 1 is a block diagram of an example of a computing environment to implement access control of one or more nodes using a certificate authority according to some examples of the present disclosure.

FIG. 2 is a block diagram of an example of a computing device to implement access control of one or more nodes using a certificate authority according to some examples of the present disclosure.

FIG. 3 is a flowchart of a process to implement access control of one or more nodes using a certificate authority according to some examples of the present disclosure.

FIG. 4 is a flowchart of a process to determine whether an access request generated by a node is valid according to some examples of the present disclosure.

### DETAILED DESCRIPTION

Role-based access control is becoming increasingly popular for use in protecting system resources from unauthorized access. Role-based access control can manage access control based on one or more roles assigned to entities, such as nodes in a distributed computing system. Based on the role(s) of a particular node, a role-based access control system can determine whether to allow or deny an access request, such as a read request or a write request, generated by the particular node. Assigning the role of a node can be cumbersome or inefficient. For instance, a role-based access control system may rely on architecture in which a service is executed to map each authorized node to its corresponding role(s) and to map each role to a corresponding access level. In certain applications, such as in an edge network or an automotive application, system resources may be limited or constrained. Running the service to implement role-based access control can be resource intensive or costly with respect to system resources.

Additionally, the role-based access control system may have limited flexibility or unamenable to change. For instance, role-based access control systems typically assign the role(s) of each node by retrieving an identifier associated with each entity and searching a list of known nodes using the retrieved identifier. Generating the list of known nodes can involve pre-configuring each node with its respective access level. Additionally, adding new nodes to the role-based access control system can involve changes to the architecture or infrastructure of the role-based access control system, which can be inefficient with respect to resources or time. For instance, existing nodes may need to be adjusted or modified based on a new node being added or to indicate that the new node can perform certain tasks.

Some examples of the present disclosure can overcome one or more of the issues mentioned above by using a certificate authority to implement access control of a node in a distributed computing system. The distributed computing system can include one or more nodes that may each have different access permissions. Examples of the nodes can include edge devices, resource-constrained devices, containers, virtual machines, servers, etc. Rather than configuring an individual set of access permissions corresponding to each node, a role-based access control system can define a suitable set of access permissions pertaining to a respective access role. Each node in the distributed computing system can be assigned a respective access role that grants suitable access permissions for the node to perform its functionality. The access permissions of a node can control or restrict access of the node to system resources of the distributed computing system. The system resources can include other nodes in the distributed computing system, other computing systems, networks, or other computing resources, such as processing power, storage, etc.

In some cases, the role-based access control system can include one or more certificate authorities that can generate and distribute access certificates to the nodes of the distributed computing system. Each certificate authority can correspond to a respective access role provided by the role-based access control system. The access certificates generated by the certificate authorities can be traced back to a respective certificate authority and can indicate the respective access role. Accordingly, the access certificates can be used to authenticate the nodes to which the access certificates are assigned. Instead of maintaining a list including each node and a respective mapping of each node to a corresponding access role, the corresponding access role of a particular node can be determined based on its access certificate(s). A new node added to existing nodes in the distributed computing system can include one or more access certificates that can allow the new node to perform its tasks or functionality. The existing nodes that may interact with the new node, such as by transmitting or receiving access requests, can validate the interactions using the access certificates. For instance, based on verifying that the access certificates are signed by an expected certificate authority, the existing nodes can accept or allow the access requests generated by the new node. Accordingly, the certificate authorities can streamline role-based access control of the nodes in the distributed computing system. Additionally, the access certificates generated by the certificate authorities can include a respective encryption key that can correspond to a respective access role associated with the access certificates. A node that lacks certain access permissions to perform an action may be unable to generate a request that is decryptable to perform the action.

In some cases, the certificate authorities can enable dynamic adjustments to the role-based access control system. For instance, if a node in the distributed computing system is compromised, the role-based access control system can revoke a particular access certificate assigned to the compromised node. Revoking the particular access certificate can be implemented without affecting the remaining nodes in the distributed computing system. Additionally, each node of the distributed computing system can be configured to understand the respective access permissions granted by each certificate authority, such as based on the access certificates issued by the certificate authorities. Accordingly, adding new nodes to the distributed computing system can be streamlined, rather than changing an underlying infrastructure of the role-based access control system. For instance, providing an access certificate to a new node added to the distributed computing system can be sufficient to implement role-based access control. Requests received or sent by the new node can be allowed or denied based on the access certificate of the new node.

In one particular example, an access control system can implement role-based access control for a distributed computing system by transmitting a respective access certificate to each node in the distributed computing system. A node of the distributed computing system can be determined to have an access role restricting the node to read permissions. In other words, the node may be unauthorized to perform other actions, such as writing, updating, deleting, etc. Once the access role of a node is determined, the access control system can identify a certificate authority that corresponds to the access role of the node. The certificate authority can be an entity or program of the access control system that can issue a digital certificate as an access certificate to the node that can indicate the read permissions of the node. Additionally, the certificate authority can transmit the digital certificate to other nodes in the distributed computing system that share the same access role.

As an example, if the node transmits a read request to another node in the distributed computing system, the other node can determine whether to allow the read request based on the digital certificate included with the read request. For instance, the other node can use the digital certificate to determine that read permissions associated with the read request are granted to the node. Accordingly, the other node can allow the node to perform a read operation indicated in the read request. On the other hand, if the node were to transmit a write request to the other node, the other node may reject the write request based on the node lacking permission to perform a write operation. For instance, the write request generated by the node may lack a corresponding access certificate that can be used by the other node to validate the write request. Once the other node determines that the write request is invalid or is unable to validate the write request, the other node can reject the write request. Accordingly, the digital certificate issued by the certificate authority can facilitate role-based access control of the node.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

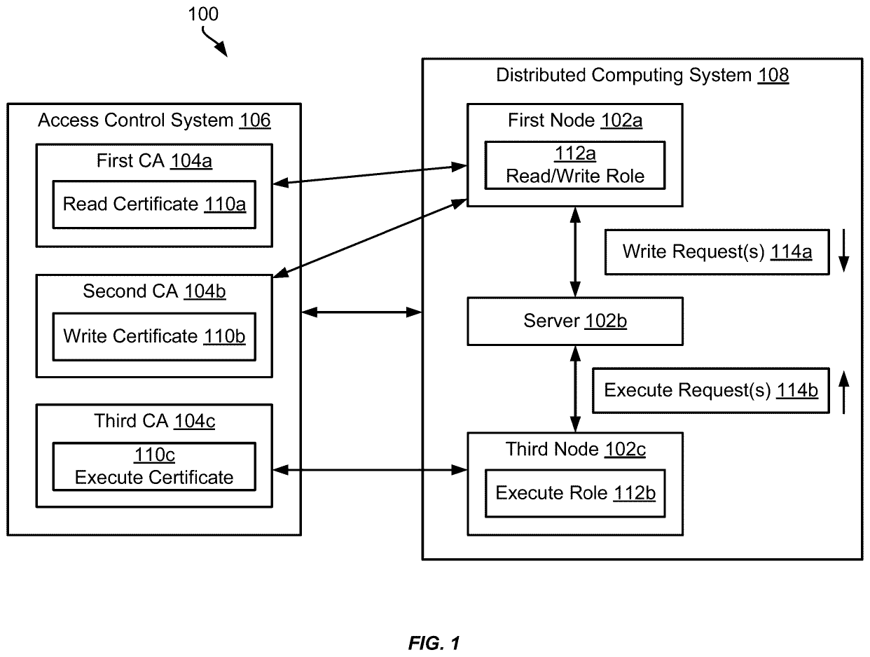

FIG. 1 is a block diagram of an example of a computing environment 100 to implement access control of one or more nodes 102 using a certificate authority 104 according to some examples of the present disclosure. In some examples, components within the computing environment 100 may be communicatively coupled via a network, such as a local area network (LAN), wide area network (WAN), the Internet, or any combination thereof. As shown, the computing environment 100 can include an access control system 106 and a distributed computing system 108 that are communicatively coupled. In some implementations, the access control system 106 may be part of the distributed computing system 108. In other implementations, the access control system 106 and the distributed computing system 108 can be separate computing systems.

In some examples, the access control system 106 can include at least one certificate authority to generate one or more access certificates 110 (e.g., a digital certificate) that can be used to implement access control. For example, as shown in FIG. 1, the access control system 106 includes a first certificate authority 104a, a second certificate authority 104b, and a third certificate authority 104c. While three certificate authorities are shown, it will be appreciated that any number of certificate authorities are possible. The access control system 106 can be an administrator or a management system that can oversee the certificate authorities 104. Each certificate authority 104 can be a trusted entity of the access control system 106 that can store, sign, verify, or issue the access certificates 110. For example, each certificate authority 104 can include a respective database that can include a respective set of access certificates corresponding to each certificate authority 104. In some cases, the certificate authorities 104 can be referred to as a certification authority or a certifying authority. Each certificate authority 104 of the access control system 106 can correspond to a respective access role that can define a respective set of permissions pertaining to each access role. In some cases, a particular certificate authority may correspond to more than one access role.

As an example, the first certificate authority 104a can correspond to a read role (e.g., an access role 112 that grants read permissions). Accordingly, a first access certificate 110a (e.g., a read certificate as shown in FIG. 1) generated or issued by the first certificate authority 104a can be used to verify read operations (e.g., retrieving data from a storage device or a memory location). Similarly, the second certificate authority 104b can correspond to a write role (e.g., an access role 112 that grants write permissions). A second access certificate 110b (e.g., a write certificate) generated by the second certificate authority 104b can be used to authorize write operations (e.g., recording or storing data into a storage medium). The third certificate authority 104c can correspond to an execute role (e.g., an access role 112 that grants execute permissions). A third access certificate 110c (e.g., an execute certificate) provided by the third certificate authority 104c can be used to allow execute operations (e.g., implementing or carrying out a program, instruction, or command).

In some examples, each access certificate (e.g., the access certificates 110a-c) can include a digital signature of a respective certificate authority that issued or generated the access certificate. For example, each certificate authority can sign its access certificates 110, such as to indicate a validity of each access certificate or to provide an identifier by which to identify the issuing certificate authority. The access certificates 110 can indicate a cipher, an encryption key (e.g., a private key), or a cryptographic algorithm used by the respective certificate authority to generate the digital signature. Accordingly, the digital signature can function as a unique identifier (e.g., an issuer identifier) that can link each access certificate to a corresponding certificate authority that generated the access certificate. Additionally, in some cases, the access certificates 110 can include an issue date that can indicate a time and/or date when the access certificates 110 were generated. Other components of the access certificates 110 can include an expiration date. For example, the access certificates 110 may be valid for a limited time window. The access certificates 110 may expire or become invalid once the expiration data has passed. In some examples, the access certificates 110 can include a separate encryption key (e.g., a public key of an asymmetric cryptographic key pair). The public key can be used to decrypt or otherwise verify the digital signature of the certificate authorities 104 that can be encrypted using the private key.

Once the certificate authorities 104 generate the access certificates 110, the certificate authorities 104 can transmit a set of access certificates to a respective node of one or more nodes 102 in the distributed computing system 108. Each access certificate can grant or indicate a respective set of permissions with respect to a corresponding node that receive the access certificate from the certificate authorities 104. In some cases, a particular certificate authority may transmit its access certificate to more than one node in the distributed computing system 108. Each node in the distributed computing system 108 can perform one or more operations or tasks. Examples of the nodes 102 can include an edge device, a computing device, a server, a container, a virtual machine, etc. Accordingly, the nodes 102 may each have a respective processor (e.g., a hardware processing device), a respective non-transitory computer-readable memory, or other suitable components that the nodes 102 may use to execute their operations or tasks.

The operations or tasks performed by the nodes 102 can each correspond to a particular access type or request type (e.g., create, read, write, update, delete, execute, etc.). The access certificates 110 transmitted to the nodes 102 can be used to implement access control with respect to determining or restricting which actions or operations each node is allowed to perform. In particular, the access certificates 110 can be used to implement role-based access control. Each node in the distributed computing system 108 can be assigned a respective access role, which can correspond to (e.g., be the same as) the access roles associated with the certificate authorities 104. The access roles of the nodes 102 can indicate a respective set of permissions granted to each node that delineates allowable operations that the nodes 102 can perform. In some cases, the access control system 106 may assign each access role to the nodes 102. Additionally or alternatively, the certificate authorities 104 may authenticate or verify the nodes 102 prior to issuing the access certificates 110. For example, a certificate authority 104 may confirm that an access role of a particular node matches the access role of the certificate authority 104 before transmitting an access certificate 110 to the particular node.

As shown, a first node 102a of the distributed computing system 108 can be assigned a read/write role 112a. The read/write role 112a can include permissions from two different roles, such as a read role (e.g., the read role of the first certificate authority 104a) and a write role (e.g., the write role of the second certificate authority 104b). Accordingly, in some implementations, a particular access role can be a combination of two or more access roles 112. Non-limiting examples of the combination of the access roles 112 can include read/write, update/delete, create/execute, etc. The certificate authorities 104 can issue separate access certificates 110 based on the combination of the access roles 112. For instance, the first node 102a can receive the first access certificate 110a and the second access certificate from the first certificate authority 104a and the second certificate authority 104b, respectively. Additionally or alternatively, a particular certificate may generate an access certificate that can account for the combination of the access roles 112. For example, a different certificate authority (not shown) may generate a read/write certificate that can be used to indicate suitable permissions related to both read operations and write operations.

Based on its read/write role 112a, the first node 102a can be authorized or allowed to generate one or more access requests 114 to perform read operations or write operations. In particular, the first node 102a may generate one or more read requests, one or more write requests 114a, or a combination thereof to perform its operations. Each access request can include or be generated using a corresponding access certificate. For example, the first node 102a may determine that performing a write operation involves generating a write request 114a. Based on the request type of the write request 114a, the first node 102a can select the write certificate 110b received from the second certificate authority 104b to generate the write request 114a. The write certificate 110b can be compatible with the write request 114a such that the write certificate 110b is associated with suitable permissions to allow the write operation indicated in the write request 114a. In particular, the first node 102a can select the write certificate 110b based on the second certificate authority 104b that issued the write certificate 110b being associated with the write role and having granted write permissions to the first node 102a. The write permissions can indicate that the write operation is an allowable operation that the first node 102a is authorized to perform.

In other words, if the first node 102a uses the write certificate 110b to generate the write request 114a, a receiving node that receives the write request 114a can use the write certificate 110b to verify the write request 114a. For example, the receiving node may be a second node 102b of the distributed computing system 108. As shown, the second node 102b can be a server. In some cases, at least one node of the distributed computing system 108 may lack an access certificate 110, as shown with respect to the second node 102b in FIG. 1. Once the second node 102b receives the write request 114a, the second node 102b can verify whether the first node 102a has been granted write permissions that enable or allow the first node 102a to perform the write operation. As described herein, the second node 102b can use the write certificate 110b to identify the second certificate authority 104b that created the write certificate 110b. For example, the write certificate 110b can include an issuer identifier that can indicate which certificate authority issued the write certificate 110b.

Once the second node 102b identifies the second certificate authority 104b, the second node 102b can determine that the second certificate authority 104b is a trusted entity that has granted write permissions to the first node 102a. For example, the second node 102b can maintain a database or list of trusted certificate authorities. Using the issuer identifier provided in the write certificate 110b, the second node 102b can determine that the second certificate authority 104b is part of the trusted certificate authorities. By verifying the second certificate authority 104b, the second node 102b can trust that the permissions granted by the second certificate authority 104b to the first node 102a are valid. Accordingly, the second node 102b can use the second certificate authority 104b to verify the write permissions granted to the first node 102a based on its write role, thereby implementing role-based access control.

Conversely, if the first node 102a were to use the read certificate 110a to generate the write request 114a, the receiving node or another component in the distributed computing system 108 that receives the write request 114a would be unable to verify the write request 114a. For example, once the second node 102b receives the write request 114a, the second node 102b can identify the read certificate 110a included as part of the write request 114a. In other words, the first node 102a may transmit the read certificate 110a along with or included in the write request 114a to the second node 102b. Using the read certificate 110a, the second node 102b can determine that the first certificate authority 104a signed and issued the read certificate 110a.

In some examples, the second node 102b can communicate or interact with the first certificate authority 104a to verify whether the first node 102a is allowed to perform the write operation of the write request 114a. For example, the second node 102b can determine an access role, a set of permissions, or a combination thereof that is associated with the first certificate authority 104a. The second node 102b can compare the access role or the set of permissions of the first certificate authority 104a to write permissions involved in performing the write operation of the write request 114a. Based on this comparison, the second node 102b can determine that the set of permissions provided by the first certificate authority 104a is incompatible with the write permissions to perform the write operation. The second node 102b can be unable to use the read certificate 110a to verify that the first node 102a is authorized to perform the write operation. Consequently, the second node 102b can reject or deny the write request 114a that is generated using the read certificate 110a. Based on the write request 114a being denied by the second node 102b, the first node 102a can be prevented from performing the write operation.

As shown in FIG. 1, the distributed computing system 108 can include a third node 102c that is assigned an execute role 112b. Accordingly, the third node 102c can receive the third access certificate 110c provided by the third certificate authority 104c that indicates execute permissions granted to the third node 102c. The third node 102c can generate one or more execute requests 114b to perform its tasks. As shown, the third node 102c may transmit the execute requests 114b to the second node 102b. As described above with respect to the write requests 114a generated by the first node 102a, the second node 102b can use the third access certificate 110c associated with the execute requests 114b to determine whether to allow the execute requests 114b. By allowing the execute requests 114b, the second node 102b can enable the third node 102c to perform one or more execute operations, such as to run a software application, program, function, etc.

In some implementations, the access control system 106 may determine that a particular node in the distributed computing system 108 has been compromised. For example, a monitoring component of the distributed computing system 108 can detect that a malicious actor has accessed or attempted to access the compromised node. The monitoring component can communicate with the access control system 106, such as by transmitting a revoke request to the access control system 106 that identifies the compromised node. To prevent unauthorized access of the remaining nodes or other system resources of the distributed computing system 108, the access control system 106 can revoke each access certificate of the compromised node. By revoking the access certificate(s) of the compromised node, the access control system 106 can invalidate or remove permissions associated with the compromised node.

In some examples, the access control system 106 can track (e.g., using a list) which nodes have a respective access certificate generated by each certificate authority 104. Additionally or alternatively, the certificate authority 104 can manage and provide this information to the access control system 106. If the first node 102a was compromised, the access control system 106 can communicate with the first certificate authority 104a and the second certificate authority 104b to revoke the first and second access certificates 110a-b. On the other hand, if the third node 102c was compromised, the access control system 106 may instruct the third certificate authority 104c to revoke the third access certificate 110c. By revoking the access certificate(s) 110, the compromised node may lack sufficient permissions to perform its typical operations, thereby preventing the malicious actor from exploiting permissions previously granted to the compromised node.

As described herein, in some examples, the access certificates 110 can include a respective expiration date that can indicate a validity period within which the access certificates 110 are valid. For example, the access certificates 110 may expire after a predefined number of minutes, hours, days, months, or years. An expired access certificate can be invalid. Accordingly, the nodes 102 may be unable to use the expired access certificate to validate access permissions of other nodes and can reject any access requested generated using the expired access certificate.

In some examples, the access certificates 110 can be renewed to extend the validity period. For example, the access roles 112 of the nodes 102 can be evaluated after a predefined time interval has passed, such as to determine whether the permissions granted by the access roles 112 are still relevant. Based on the evaluation, the access certificates 110 assigned to the nodes 102 may be renewed to extend the validity period or replaced with a different access certificate that defines a different set of permissions. As another example, a new access certificate can be issued to replace an existing access certificate that is close to expiration where the new access certificate is configured to expire after the existing access certificate. The new access certificate can be generated by the same certificate authority that generated the existing access certificate and can be used to verify the same access permissions.

While FIG. 1 depicts a specific arrangement of components, other examples can include more components, fewer components, different components, or a different arrangement of the components shown in FIG. 1. For instance, in other examples, a different number of certificate authorities 104 or nodes 102 may be present in the access control system 106 or the distributed computing system 108, respectively. Additionally, any component or combination of components depicted in FIG. 1 can be used to implement the process(es) described herein.

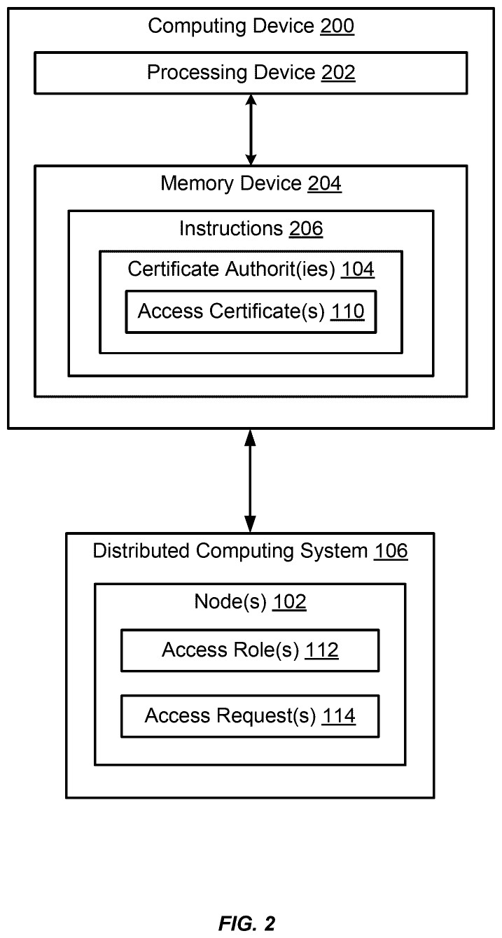

FIG. 2 is a block diagram of an example of a computing device 200 to implement access control of one or more nodes 102 using a certificate authority 104 according to some examples of the present disclosure. In some implementations, the computing device 200 can include or implement the access control system 106 of FIG. 1. Examples of the computing device 200 can include a desktop computer, laptop computer, server, mobile phone, or tablet. The computing device 200 can include a processing device 202 communicatively coupled to a memory device 204. Additionally, the computing device 200 can be in communication with a distributed computing system 108 that includes the nodes 102.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C #, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the processing device 202 can implement role-based access control using one or more certificate authorities 104. As described herein, the certificate authorities 104 can be trusted entities that can issue one or more access certificates 110. The access certificates 110 can be used to verify access permissions of nodes 102 in a distributed computing system 108 to prevent unauthorized operations from being performed by the nodes 102. In particular, each certificate authority can be associated with one or more access roles 112. Each access role 112 can define a respective set of access permissions. Additionally, each node of the distributed computing system 108 can be assigned a respective access role. Accordingly, the certificate authorities 104 can assign, transmit, or issue the access certificates 110 to the nodes 102 based on a matching access role. In some examples, the processing device 202 may instruct the certificate authorities 104 to verify a respective access role of each node prior to transmitting the access certificates 110 to the nodes 102.

The access certificates 110 can enable verification of the access permissions that are granted to the nodes 102. To perform tasks or operations, the nodes 102 can generate one or more access requests 114. The access requests 114 can include or be generated using the access certificates 110 transmitted to the nodes 102. The access certificates 110 can be used by a receiving entity that receives the access requests 114 to identify a corresponding certificate authority that issued the access requests. For example, the processing device 202 can receive communication (e.g., a message or a verification request) that includes an issuer identifier included in the access certificates 110. Based on the issuer identifier, the processing device 202 can determine the corresponding certificate authority. The processing device 202 may provide a response indicate an identity of the corresponding certificate authority. Additionally, the response can include a set of access permissions granted by the corresponding certificate authority.

Access permissions needed to resolve the access requests 114 can be compared with the sets of access permissions granted by the certificate authorities to determine whether the access requests 114 are allowable. For example, if a first node 102a receives an access request 114 from a second node 102b to perform an update operation, the first node 102a can verify whether the second node 102b is authorized to perform the update operation. In particular, the first node 102a can determine a corresponding set of access permissions granted to the second node 102b based on the corresponding certificate authority of the second node 102b. If the corresponding certificate authority is unassociated with update permissions, the first node 102a can deny the access request 114. Conversely, if the corresponding set of access permissions include suitable update permissions, the first node 102a can allow the access request 114 such that the second node 102b can be allowed to perform the update operation.

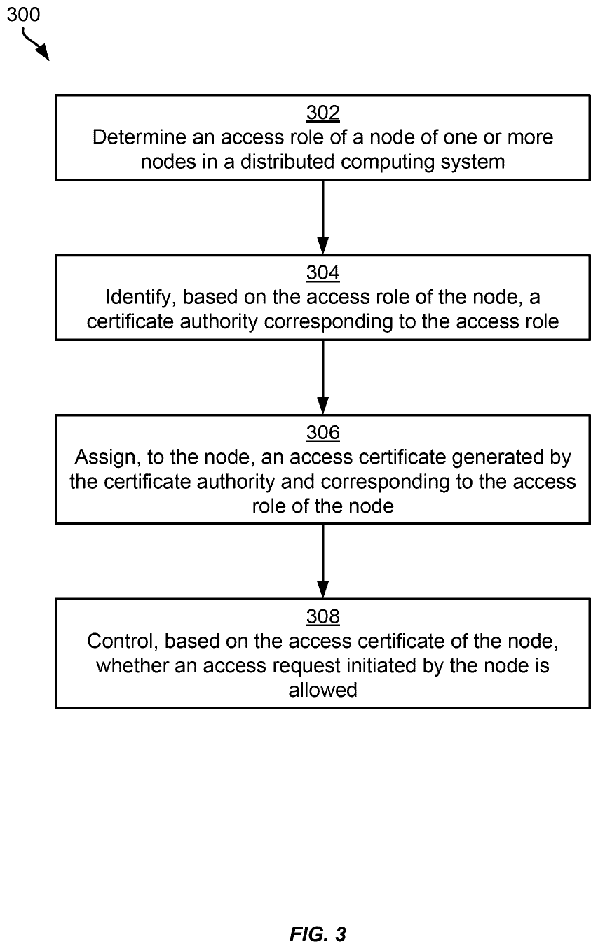

FIG. 3 is a flowchart of a process 300 to implement access control of one or more nodes 102 using a certificate authority 104 according to some examples of the present disclosure. In some examples, the processing device 202 can perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

In block 302, the processing device 202 determines an access role 112 of a node (e.g., the first node 102a of FIG. 1) of the nodes 102 in a distributed computing system 108. The access role 112 can define one or more permissions (e.g., access permissions) of the node 102 with respect to accessing system resources of the distributed computing system 108. The system resources can include other nodes, networks, or computing resources (e.g., processor power, cores, storage, etc.). For example, the first node 102a has an access role related to read permissions and write permissions. Accordingly, the first node 102a can be permitted or allowed to perform read operations, write operations, or a combination thereof based on the access role assigned to the first node 102a and the permissions afforded by the access role.

In block 304, the processing device 202 identifies, based on the access role 112 of the node 102, the certificate authority 104 corresponding to the access role 112. In particular, the processing device 202 can assign a respective access role to both the nodes 102 and one or more certificate authorities 104. In some examples, the processing device 202 may select the certificate authority 104 from a group of certificate authorities based on the access role 112 of the node 102 and the certificate authority 104 matching or being compatible. The processing device 202 can identify more than one certificate authority as corresponding to the access role 112 of the node 102. For example, the first node 102a of FIG. 1 has a read/write role 112a as its access role. Accordingly, the processing device 202 can determine that a first certificate authority 104a having a read role and a second certificate authority that is assigned a write role both correspond to the first node 102a with the read/write role 112a.

In block 306, the processing device 202 assigns, to the node 102, an access certificate 110 generated by the certificate authority 104 and corresponding to the access role 112 of the node 102. The access certificate 110 can correspond to the access role 112 such that the access certificate 110 can be used to validate a set of permissions related to the access role 112. For example, the read/write role 112a of the first node 102a can correspond to a combination of read permissions and write permissions such that the first node 102a is allowed to perform read operations and write operations. In some examples, the access certificate 110 can include an issuer identifier that can be used to identify the certificate authority 104 that generated the access certificate 110.

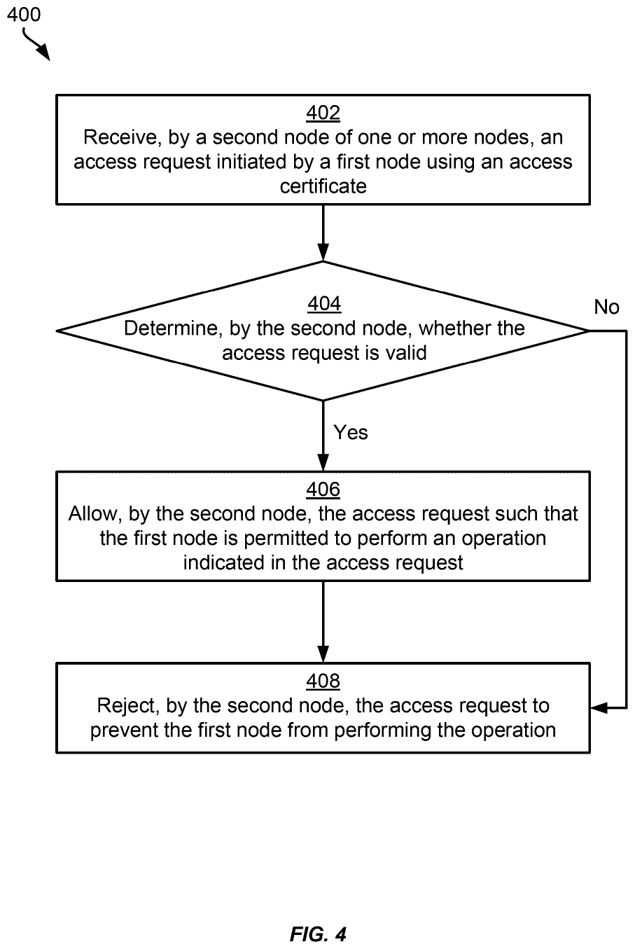

In block 308, the processing device 202 controls, based on the access certificate 110 of the node 102, whether an access request 114 initiated by the node 102 is allowed. The access request 114 can be initiated by the node 102 to perform an operation that can involve accessing system resources in the distributed computing system 108. For example, the first node 102a can generate a read request as the access request 114 to perform a read operation to access one or more data entries stored in a database of the distributed computing system 108. Prior to providing the first node 102a access to the data entries, the database can communicate with the processing device 202 to verify that the first node 102a has suitable permissions or authorization to access the data entries. Additional details related to access control using the access certificate 110 is described below with respect to FIG. 4.

FIG. 4 is a flowchart of a process to determine whether an access request 114 generated by a node 102 is valid according to some examples of the present disclosure. In some examples, the processing device 202 can perform one or more of the steps shown in FIG. 4. In other examples, validation of the access request 114 generated by the node can be performed by another node. For example, a second node 102b can validate the access request 114 generated by a first node 102a. Additionally or alternatively, the processing device 202 or the second node 102b can implement more steps, fewer steps, different steps, or a different order of the steps depicted in FIG. 4. The steps of FIG. 4 are described herein with reference to components discussed above in FIG. 1.

In block 402, the process 400 involves receiving, by a second node 102b of one or more nodes 102 in a distributed computing system 108, the access request 114 initiated by a first node 102a using an access certificate 110. As described herein, the first node 102a can initiate the access request 114 to access system resources provided in the distributed computing system 108. In particular, the access request 114 can include an operation that will be performed by the first node 102a if the access request 114 is allowed. For example, the first node 102a can generate and transmit a write request 114a to the second node 102b to perform a write operation to store or modify data in a database of the distributed computing system 108.

In block 404, the process 400 involves determining, by the second node 102b, whether the access request 114 is valid based on a certificate authority 104 (e.g., the first certificate authority 104a of FIG. 1) that generated the access certificate 110. The second node 102b can verify the access request 114 to ensure that the operation indicated in the access request 114 is permissible. In particular, the second node 102b can compare access permissions required by performing the operation and granted permissions related to the first node 102a to determine whether the access request 114 is valid. If the second node 102b determines that the access request 114 is valid, the process 400 can proceed to block 406. Conversely, if the second node 102b determines that the access request 114 is invalid, the process 400 can proceed to block 408.

In some examples, the second node 102b can use an issuer identifier provided in the access certificate 110 to map the access certificate 110 to the certificate authority 104 that generated the access certificate 110. After identifying the certificate authority 104, the second node 102b can determine the granted permissions of the first node 102a. In particular, as described herein, the access role 112 of the certificate authority 104 and the first node 102a can match such that the certificate authority 104 can indicate or be used to determine the granted permissions of the first node 102a. In some implementations, the first node 102a can be associated with more than one certificate authority, such as being associated with both the first certificate authority 104a and the second certificate authority 104b. Accordingly, the second node 102b can determine the granted permissions of both certificate authorities 104a-b to verify whether the first node 102a is authorized to perform the operation.

In block 406, the process 400 involves, in response to determining that the access request 114 is valid, allowing, by the second node 102b, the access request 114 such that the first node 102a is permitted to perform the operation indicated in the access request 114. For example, after determining the granted permissions of the first certificate authority 104a and the second certificate authority 104b, the second node 102b can verify that performing the operation is allowable based on the granted permissions. In other words, access permissions required to perform the operation can be included in the granted permissions attributed to the first node 102a. As an example, the second node 102b can determine that the granted permissions of the first node 102a include authorization for the first node 102a to store new data to a particular data entry in the database. Accordingly, the second node 102b can enable the first node 102a to access the particular data entry of the database such that the first node 102a can perform the write operation.

In block 408, the process 400 involves, in response to determining that the access request 114 is invalid, denying, by the second node 102b, the access request 114 to prevent the first node 102a from performing the operation. After comparing the granted permissions of the first node 102a and the required permissions of the access request 114, the second node 102b can determine that at least a portion of the required permissions are inconsistent with the granted permissions. In other words, based on the comparison, the second node 102b may determine that the first node 102a lacks one or more required permissions of the access request 114. Accordingly, the second node 102b can prevent the first node 102a from performing the operation based on the first node 102a lacking authorization to perform the operation.

In some examples, the second node 102b may determine that the first node lacks the required permissions based on an incorrect access certificate being provided in the access request 114. For example, if the first node 102a provide its write certificate 110b in an access request 114 to perform a read operation, the second node 102b can be unable to validate the access request 114. In particular, the second node 102b can determine that the granted permissions corresponding to the write certificate 110b are inconsistent with read permissions used to perform the read operation.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
determining an access role of a node in a plurality of nodes of a distributed computing system, the access role defining one or more permissions of the node with respect to accessing system resources of the distributed computing system;
identifying, based on the access role of the node, a certificate authority corresponding to the access role;
assigning, to the node, an access certificate generated by the certificate authority and corresponding to the access role of the node; and
controlling, based on the access certificate of the node, whether an access request initiated by the node is allowed.

2. The system of claim 1, wherein the node is a first node in the plurality of nodes, and wherein controlling whether the access request initiated by the first node is allowed comprises:
receiving, by a second node of the plurality of nodes, the access request initiated by the first node using the access certificate;
determining, by the second node, whether the access request is valid based on the certificate authority that generated the access certificate; and
in response to determining that the access request is valid, allowing, by the second node, the access request such that the first node is permitted to perform an operation indicated in the access request.

3. The system of claim 2, wherein determining that the access request is valid comprises:
identifying, by the second node using the access certificate, the certificate authority that generated the access certificate;
determining, by the second node, the one or more permissions of the first node based on the certificate authority; and
verifying, by the second node, that the operation indicated in the access request is consistent with the one or more permissions of the first node.

4. The system of claim 2, wherein the operations further comprise, in response to determining that the access request is invalid:
denying, by the second node, the access request to prevent the first node from performing the operation.

5. The system of claim 1, wherein the node is assigned a set of access certificates, and wherein each access certificate of the set of access certificates assigned to the node is generated by a respective certificate authority that grants a respective set of permissions.

6. The system of claim 5, wherein the operations further comprise, prior to initiating the access request:
determining a request type of the access request;
selecting, by the node from the set of access certificates, a particular access certificate compatible with the request type; and
generating, by the node, the access request using the selected access certificate.

7. The system of claim 1, wherein the operations further comprise:
determining that the node has been compromised; and
in response to determining that the node has been compromised, revoking the access certificate of the compromised node to remove the one or more permissions associated with the compromised node.

8. A method comprising:
determining an access role of a node in a plurality of nodes of a distributed computing system, the access role defining one or more permissions of the node with respect to accessing system resources of the distributed computing system;
identifying, based on the access role of the node, a certificate authority corresponding to the access role;
assigning, to the node, an access certificate generated by the certificate authority and corresponding to the access role of the node; and
controlling, based on the access certificate of the node, whether an access request initiated by the node is allowed.

9. The method of claim 8, wherein the node is a first node in the plurality of nodes, and wherein controlling whether the access request initiated by the first node is allowed comprises:
receiving, by a second node of the plurality of nodes, the access request initiated by the first node using the access certificate;
determining, by the second node, whether the access request is valid based on the certificate authority that generated the access certificate; and
in response to determining that the access request is valid, allowing, by the second node, the access request such that the first node is permitted to perform an operation indicated in the access request.

10. The method of claim 9, wherein determining that the access request is valid comprises:
identifying, by the second node using the access certificate, the certificate authority that generated the access certificate;
determining, by the second node, the one or more permissions of the first node based on the certificate authority; and
verifying, by the second node, that the operation indicated in the access request is consistent with the one or more permissions of the first node.

11. The method of claim 9, further comprising, in response to determining that the access request is invalid:
denying, by the second node, the access request to prevent the first node from performing the operation.

12. The method of claim 8, wherein the node is assigned a set of access certificates, and wherein each access certificate of the set of access certificates assigned to the node is generated by a respective certificate authority that grants a respective set of permissions.

13. The method of claim 12, further comprising, prior to initiating the access request:
determining a request type of the access request;
selecting, by the node from the set of access certificates, a particular access certificate compatible with the request type; and
generating, by the node, the access request using the selected access certificate.

14. The method of claim 8, further comprising:
determining that the node has been compromised; and
in response to determining that the node has been compromised, revoking the access certificate of the compromised node to remove the one or more permissions associated with the compromised node.

15. A non-transitory computer-readable medium comprising program code executable by a processing device for causing the processing device to perform operations comprising:
determining an access role of a node in a plurality of nodes of a distributed computing system, the access role defining one or more permissions of the node with respect to accessing system resources of the distributed computing system;
identifying, based on the access role of the node, a certificate authority corresponding to the access role;
assigning, to the node, an access certificate generated by the certificate authority and corresponding to the access role of the node; and
controlling, based on the access certificate of the node, whether an access request initiated by the node is allowed.

16. The non-transitory computer-readable medium of claim 15, wherein the node is a first node in the plurality of nodes, and wherein controlling whether the access request initiated by the first node is allowed comprises:
receiving, by a second node of the plurality of nodes, the access request initiated by the first node using the access certificate;
determining, by the second node, whether the access request is valid based on the certificate authority that generated the access certificate; and
in response to determining that the access request is valid, allowing, by the second node, the access request such that the first node is permitted to perform an operation indicated in the access request.

17. The non-transitory computer-readable medium of claim 16, wherein the operations further comprise:
identifying, by the second node using the access certificate, the certificate authority that generated the access certificate;
determining, by the second node, the one or more permissions of the first node based on the certificate authority; and
verifying, by the second node, that the operation indicated in the access request is consistent with the one or more permissions of the first node.

18. The non-transitory computer-readable medium of claim 16, wherein the operations further comprise, in response to determining that the access request is invalid:
denying, by the second node, the access request to prevent the first node from performing the operation.

19. The non-transitory computer-readable medium of claim 15, wherein the node is assigned a set of access certificates, and wherein each access certificate of the set of access certificates assigned to the node is generated by a respective certificate authority that grants a respective set of permissions.

20. The non-transitory computer-readable medium of claim 19, wherein the operations further comprise, prior to initiating the access request:
determining a request type of the access request;
selecting, by the node from the set of access certificates, a particular access certificate compatible with the request type; and
generating, by the node, the access request using the selected access certificate.
